(19) United States
(12) Patent Application Publication
(10) Pub. No.: US 2017/0037600 A1
(43) Pub. Date: Feb. 9, 2017

(54) DRIVE CONTROL DEVICE FOR CONSTRUCTION EQUIPMENT AND CONTROL METHOD THEREFOR

(71) Applicant: VOLVO CONSTRUCTION EQUIPMENT AB, Eskilstuna (SE)

(72) Inventors: Hea-Gyoon JOUNG, Busan (KR); Jae-Hoon LEE, Changwon-si (KR); Sang-Hee LEE, Gimhae-si (KR)

(73) Assignee: VOLVO CONSTRUCTION EQUIPMENT AB, Eskilstuna (SE)

(21) Appl. No.: 15/303,942

(22) PCT Filed: Apr. 15, 2014
(86) PCT No.: PCT/KR2014/003263

§ 371 Date: Oct. 13, 2016

(51) Int. Cl. E02F 9/22; F15B 13/06; F15B 21/00; F15B 11/17; F15B 11/16

(52) U.S. Cl. CPC E02F 9/2242; E02F 9/2292; E02F 9/2232; E02F 9/2296; E02F 9/2285; F15B 11/17; F15B 11/166; F15B 21/008; F15B 13/06

(57) ABSTRACT

Disclosed is a drive control device for the construction equipment capable of reducing shock generation and smoothly operating a work device when the work device is operated during the driving, which comprises; a first and second hydraulic pumps and a pilot pump, a first work device and a first drive motor operated by a hydraulic oil of the first hydraulic pump, a second work device and a second drive motor operated by a hydraulic oil of the second hydraulic pump, a first drive control valve and a first work device control valve that are provided on the supply path of the first hydraulic pump, a second drive control valve and a second work device control valve that are provided on the supply path of the second hydraulic pump, a linear drive control valve that is provided at the upper side of the supply path of the second hydraulic pump, a parallel path having an inlet branched and connected to the upper side of the supply path of the second hydraulic pump and an outlet connected to the inlet port of the second work device control valve, a branch path having an inlet branched and connected to a predetermined position of the parallel path and an outlet branched and connected to a path between the linear drive control valve and the second drive control valve, a fixed orifice provided on the branch path, and a first ratio control valve provided on a path between the pilot pump and the linear drive control valve.

### TECHNICAL FIELD

The present invention relates to a drive control device for the construction equipment and a control method therefor, and more particularly, a drive control device for a construction equipment and a control method therefor capable of reducing shock generation and smoothly operating a work device when the multiple activities are performed by operating a work device during the driving.

### BACKGROUND OF THE INVENTION

A drive control device for the construction equipment according to the conventional technology as shown in FIG. 1 comprises;

a variable capacity type of a first and second hydraulic pumps (hereinafter, a first and a second hydraulic pump) (P1,P2) and a pilot pump (11),

a first work device and a first drive motor (not shown in Figure) operated by a hydraulic oil of the first hydraulic pump (P1),

a second work device and a second drive motor (not shown in Figure) operated by a hydraulic oil of the second hydraulic pump (P2),

a first drive control valve (6a) and a first work device control valve (9) that are provided on the supply path (16) of the first hydraulic pump (P1), and in switching, control the amount and flow direction of a hydraulic oil which is fed to the first drive motor and the first work device, respectively,

a second drive control valve (6b) and a second work device control valve (8) that are provided on the supply path (17) of the second hydraulic pump (P2), and in switching, control the amount and flow direction of a hydraulic oil which is fed to the second drive motor and the second work device, respectively,

a linear drive control valve (7) that is provided at the upper side of the supply path (17) of the second hydraulic pump (P2) and maintains the drive linearity by switching when the multiple activities are performed by operating a work device with the driving,

a parallel path (21) having an inlet branched and connected to the upper side of the supply path (17) of the second hydraulic pump (P2) and an outlet connected to the inlet port of the second work device control valve (8),

a branch path having an inlet branched and connected to a predetermined position of the parallel path (21) and an outlet branched and connected to a path (20) between the linear drive control valve (7) and the second drive control valve (6b),

a check valve and a fixed orifice (13) provided on the branch path (24), the fixed orifice preventing the hydraulic oil from being weighted towards the drive side from the second hydraulic pump (P2) in case that the load pressure applied to a work device is higher than that applied to the drive when the linear drive control valve (7) is switched for the multiple activities of operating a work device with the driving

a solenoid valve (5) provided on a path (18) between the pilot pump (11) and the linear drive control valve (7), the solenoid valve (5) being switched by the electrical signal and thereby feeding the hydraulic oil of the pilot pump (11) to the linear drive control valve (7),

a first pressure sensor (12d) detecting the operating oil amount of a first drive operation device (3a) for switching the first drive control valve (6a),

a second pressure sensor (12c) detecting the operating oil amount of a second drive operation device (3b) for switching the second drive control valve (6b),

a third pressure sensor (12b) detecting the operating oil amount of a first work device lever (4b) for switching the first work device control valve (9),

a fourth pressure sensor (12a) detecting the operating oil amount of a second work device lever (4a) for switching the second work device control valve (8), and

a controller (10) that calculates the operation signals inputted from the first, second, third and fourth pressure sensors (12d, 12c, 12b, 12a), and applies the electrical signal to the solenoid valve (5) for the switching thereof.

The number 2 without instruction in the Figure is a main control valve (MCV).

According to the conventional drive control device, the first drive control valve (6a) is switched to the left in the figure with the second drive control valve (6b) switched to the right by applying the pilot pressures by operating the first and second drive operation devices (3a, 3b), where the operating oil amounts of the first and second drive operation devices (3a, 3b) are detected by the first and second pressure sensors (12d, 12c) and the operation signals are inputted to the controller (10).

Accordingly, a portion of the operating oil of the first hydraulic pump (P1) is fed to the supply path (16) and the first drive control valve (6a), while another portion of the operating oil of the first hydraulic pump (P1) is fed to the first work device control valve (9) through the path (22) and the linear drive control valve (7).

On the other hand, a portion of the operating oil of the second hydraulic pump (P2) is fed to the path (17), the linear drive control valve (7), the path (20), and the second drive control valve (6b), while another portion of the operating oil of the second hydraulic pump (P2) is fed to the second work device control valve (8) via the parallel path (21), and also fed to the second drive control valve (6b) through a check valve on the branch path (24) and the fixed orifice (13).

In the case that a work device is operated by the first and second work device lever (4b, 4a) (multiple activities of driving and operating work device), the third and fourth pressure sensors (12b, 12a) detect the operating oil amount and input the operation signal to the controller (10) which then switches the solenoid valve (5) to on-state by the electrical signal. That is, due to the switching of solenoid valve (5), the linear drive control valve (7) is switched to the left in the figure by the pilot pressure from the pilot pump (11).

By this operation, a portion of the operating oil of the first hydraulic pump (P1) is fed to the supply path (16) and the first drive control valve (6a), while another portion of the operating oil of the first hydraulic pump (P1) is fed to the second drive control valve (6b) along with the supply path (16), the path (22), the linear drive control valve (7), and the path (20).

On the other hand, a portion of the operating oil of the second hydraulic pump (P2) is fed to the first work device control valve (9) by way of the path (17), the linear drive control valve (7), and the path (19), while another portion of the operating oil of the second hydraulic pump (P2) is fed to the second work device control valve (8) via the supply path (17) and the parallel path (21), and also fed to the second drive control valve (6b) through the parallel path (21) and the fixed orifice (13) on the branch path (24).

As described above, by the switching of the linear drive control valve (7) during the multiple activities, the operating oil of the first hydraulic pump (P1) is fed to both the left and right sides of the drive, a portion of the second hydraulic pump (P2) fed to the work device, and another portion of the second hydraulic pump (P2) fed to the drive via the fixed orifice (13).

In this case, the first and second drive motors are operated by the operating oil fed from the first and second hydraulic pumps (P1, P2), respectively, where the shock is generated due to a lack of the operating oil feed since the first and second drive motors during the multiple activities are operated by the operating oil mostly fed from the first hydraulic pump (P1) by the switching of the linear drive control valve (7) enabled by the solenoid valve (5).

In addition, in case of lifting the heavy body during the driving, the load pressure generated on the work device becomes relatively higher than the load pressure generated on the drive. Thus, the operating oil fed to the second work device control valve (8) through the parallel path (21) from the second hydraulic pump (P2) is weighted towards the drive via the fixed orifice (13).

This hinders smooth lifting of the heavy body, and an attempt could be made to reduce the aperture area of the fixed orifice (13), which may facilitate the lifting, but causes the problem of making the shock worse.

### SUMMARY OF THE INVENTION

### Technical Solution

Accordingly, the present invention has been made to solve the aforementioned problems, and it is an object of the present invention to provide a drive control device for a construction equipment and a control method therefor which can improve the operability and reliability by reducing shock generation and smoothly operating a work device when a work device is operated during the driving.

To achieve the above and other objects, in accordance with an embodiment of the present invention, there is provided

a first and second hydraulic pumps and a pilot pump,

a first work device and a first drive motor operated by a hydraulic oil of the first hydraulic pump,

a second work device and a second drive motor operated by a hydraulic oil of the second hydraulic pump,

a first drive control valve and a first work device control valve that are provided on the supply path of the first hydraulic pump, and in switching, control the amount and flow direction of a hydraulic oil which is fed to the first drive motor and the first work equipment, respectively,

a second drive control valve and a second work device control valve that are provided on the supply path of the second hydraulic pump, and in switching, control the amount and flow direction of a hydraulic oil which is fed to the second drive motor and the second work equipment, respectively,

a linear drive control valve that is provided at the upper side of the supply path of the second hydraulic pump and maintains the drive linearity by switching when the multiple activities are done by operating a work device with the driving,

a parallel path having an inlet branched and connected to the upper side of the supply path of the second hydraulic pump and an outlet connected to the inlet port of the second work device control valve,

a branch path having an inlet branched and connected to a predetermined position of the parallel path and an outlet branched and connected to a path between the linear drive control valve and the second drive control valve,

a fixed orifice provided on the branch path, the fixed orifice preventing the hydraulic oil from being weighted towards the drive side from the second hydraulic pump in case that the load pressure applied to a work device is higher than that applied to the driving when the linear drive control valve is switched for the multiple activities of operating a work device with the driving, and

a first ratio control valve provided on a path between the pilot pump and the linear drive control valve, the first ratio control valve applying to the linear drive control valve the pilot pressures that are changed in proportion to the operating oil amounts required for the operation of the first and second work device levers when the multiple activities are performed by operating the work device with the driving.

According to another embodiment of the present invention, there is provided a drive control device for construction equipment comprising;

a first and second hydraulic pumps and a pilot pump,

a first work device and a first drive motor operated by a hydraulic oil of the first hydraulic pump,

a second work device and a second drive motor operated by a hydraulic oil of the second hydraulic pump,

a first drive control valve and a first work device control valve that are provided on the supply path of the first hydraulic pump, and in switching, control the amount and flow direction of a hydraulic oil which is fed to the first drive motor and the first work equipment, respectively,

a second drive control valve and a second work device control valve that are provided on the supply path of the second hydraulic pump, and in switching, control the amount and flow direction of a hydraulic oil which is fed to the second drive motor and the second work equipment, respectively,

a linear drive control valve that is provided at the upper side of the supply path of the second hydraulic pump and maintains the drive linearity by switching when the multiple activities are performed by operating a work device with the driving,

a parallel path having an inlet branched and connected to the upper side of the supply path of the second hydraulic pump and an outlet connected to the inlet port of the second work device control valve,

a branch path having an inlet branched and connected to a predetermined position of the parallel path and an outlet branched and connected to a path between the linear drive control valve and the second drive control valve,

a fixed orifice provided on the branch path, the fixed orifice preventing the hydraulic oil from being weighted towards the drive side from the second hydraulic pump in the case that the load pressure applied to a work device is higher than that applied to the driving when the linear drive control valve is switched for the multiple activities of operating a work device with the driving,

a first ratio control valve provided on a path between the pilot pump and the linear drive control valve, the first ratio control valve applying to the linear drive control valve the pilot pressures that are changed in proportion to the operating oil amounts required for the operation of the first and second work device levers when the multiple activities are performed by operating the work device with the driving, and

a second ratio control valve provided on a path between the pilot pump and the variable orifice, the second ratio control valve applying to the variable orifice the pilot pressures that are changed in proportion to the operating oil amounts required for the operation of the first and second work device levers, in which the aperture area of the variable orifice is regulated to be inversely proportional to the changed pilot pressure, when the multiple activities are performed by operating the work device with the driving.

According to another embodiment of the present invention, there is provided a drive control method for construction equipment comprising;

determining the operation state of first and second drive motors by the operation signal of a drive pressure sensor detecting the operating oil amount of the drive operation device,

determining the operation state of a work device by the operation signal of a work device pressure sensor detecting the operating oil amount of the work operation device,

blocking a pilot pressure applied to a linear drive control valve from a pilot pump when the first and second drive motors are working and the work device is not working, and

applying to the linear drive control valve the pilot pressures that are changed in proportion to the operating oil amounts required for the operation of the first and second work device levers when the first and second drive motors as well as the work device are working.

According to another embodiment of the present invention, there is provided a drive control method for construction equipment comprising;

determining the operation state of first and second drive motors by the operation signal of a drive pressure sensor detecting the operating oil amount of the drive operation device,

determining the operation state of a work device by the operation signal of a work device pressure sensor detecting the operating oil amount of the work operation device,

blocking a pilot pressure applied to a linear drive control valve from a pilot pump when the first and second drive motors are working and the work device is not working,

applying to the linear drive control valve the pilot pressures that are changed in proportional to the operating oil amounts required for the operation of the first and second work device levers when the first and second drive motors as well as the work device are working, and

applying to the variable orifice the pilot pressures that are changed in proportion to the operating oil amounts required for the operation of the first and second work device levers, in which the aperture area of the variable orifice is regulated to be inversely proportional to the changed pilot pressure when the first and second drive motors as well as the work device are working.

According to another embodiment of the present invention, there is provided a drive control device for construction equipment comprising;

a first pressure sensor detecting the operating oil amount of a first drive operation device for switching the first drive control valve,

a second pressure sensor detecting the operating oil amount of a second drive operation device for switching the second drive control valve,

a third pressure sensor detecting the operating oil amount of a first work device lever for switching the first work device control valve,

a fourth pressure sensor detecting the operating oil amount of a second work device lever for switching the second work device control valve, and

a controller that calculates the operation signals inputted from the first, second, third and fourth pressure sensors and applies the electrical signal to the first ratio control valve for the switching thereof.

According to another embodiment of the present invention, there is provided a drive control device for construction equipment comprising;

a first pressure sensor detecting the operating oil amount of a first drive operation device for switching the first drive control valve,

a second pressure sensor detecting the operating oil amount of a second drive operation device for switching the second drive control valve,

a third pressure sensor detecting the operating oil amount of a first work device lever for switching the first work device control valve,

a fourth pressure sensor detecting the operating oil amount of a second work device lever for switching the second work device control valve, and

a controller that calculates the operation signals inputted from the first, second, third and fourth pressure sensors, and applies the electrical signals to the first ratio control valve and the second ratio control valve for the switching thereof.

According to another embodiment of the present invention, there is provided a drive control device for construction equipment comprising;

a fifth pressure sensor inputting to the controller the pressure value detected from the first hydraulic pump, and

a sixth pressure sensor inputting to the controller the pressure value detected from the second hydraulic pump.

the variable orifice has an external signal port configured so that the aperture area of the variable orifice is regulated by the pilot pressure inputted externally.

the variable orifice is also characterized in that the aperture area is regulated to be inversely proportional to the difference between the load pressure generated on the work device and the load pressure generated on the drive part.

The present invention is characterized when the multiple activities are performed by operating the work device with the driving, in that if the operation pressure detected of the second hydraulic pump is lower than the predetermined pressure, the pilot pressure applied to the linear drive control valve from the first ratio control valve is reduced, and if the operation pressure detected is higher than the predetermined pressure, the pilot pressure applied to the linear drive control valve from the first ratio control valve is raised.

The present invention is further characterized when the multiple activities are performed by operating the work device with the driving, in that if the operation pressure detected of the second hydraulic pump is lower than the predetermined pressure, the pilot pressure applied to the variable orifice from the second ratio control valve is reduced so that the aperture area of the variable orifice is reduced to the predetermined area, and if the operation pressure detected is higher than the predetermined pressure, the pilot pressure applied to the variable orifice from the second ratio control valve is raised so that the aperture area of the variable orifice is reduced further below the predetermined area.

### Advantageous Effect

According to the present invention with configuration described above, the invention has the effect of improving the operability and reliability by reducing shock generation and smoothly operating a work device when a work device is operated during the driving.

### BRIEF DESCRIPTION OF THE DRAWINGS

FIG. 1 shows the hydraulic circuit of the drive control device of construction equipment according to the conventional art.

FIG. 2 represents the hydraulic circuit of the drive control device for the construction equipment according to an embodiment of the present invention.

FIG. 3 represents the hydraulic circuit of the drive control device for the construction equipment according to another embodiment of the present invention.

FIG. 4 shows the flow chart of the drive control method for the construction equipment according to an embodiment of the present invention.

FIG. 5 is the flow chart of the drive control method for the construction equipment according to another embodiment of the present invention.

FIG. 6 is the graph showing the modified control of a first ratio control valve of the drive control device for the construction equipment according to an embodiment of the present invention.

FIG. 7 is the graph showing the modified control of a second ratio control valve of the drive control device for the construction equipment according to an embodiment of the present invention.

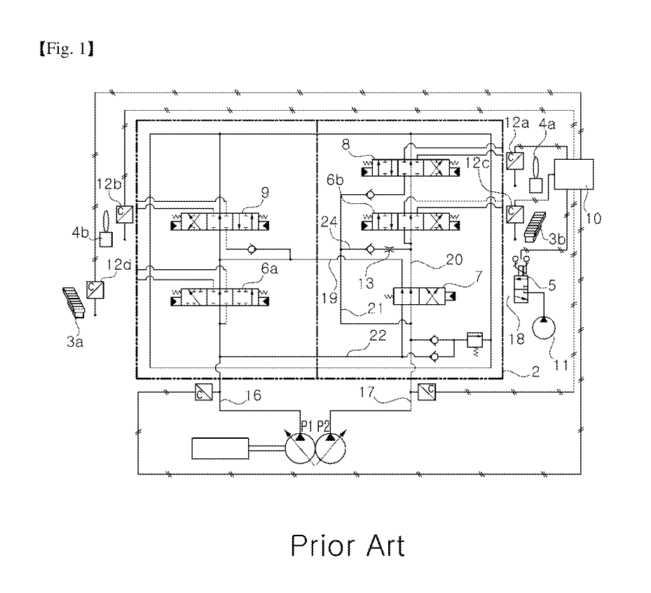

### DESCRIPTION OF THE REFERENCE NUMBERS FOR THE MAIN PARTS OF THE DRAWINGS

3a: first drive operation device
3b: second drive operation device
4a: second work device lever
4b: first work device lever
6a: first drive control valve
6b: second drive control valve
7: linear drive control valve
8: second work device control valve
9: first work device control valve
10: controller
11: pilot pump
P1: first hydraulic pump
P2: second hydraulic pump

### DETAILED DESCRIPTION OF THE INVENTION

Hereinafter, the drive control device for construction equipment and method therefor according to a preferred embodiment of the present invention will be described in detail with reference to the accompanying drawings.

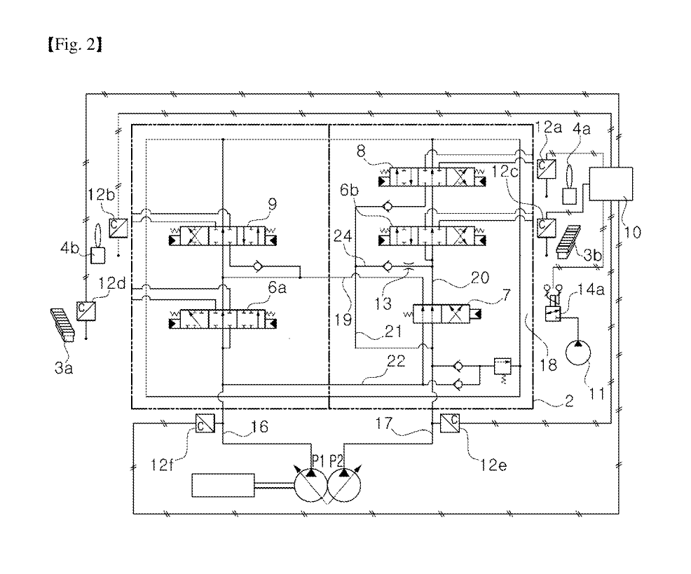

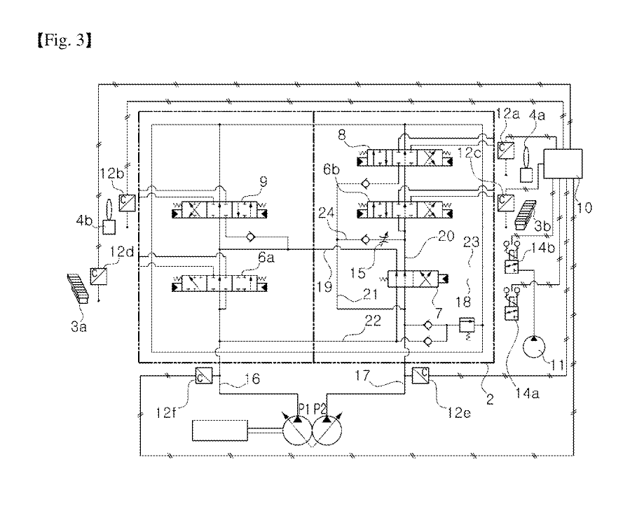

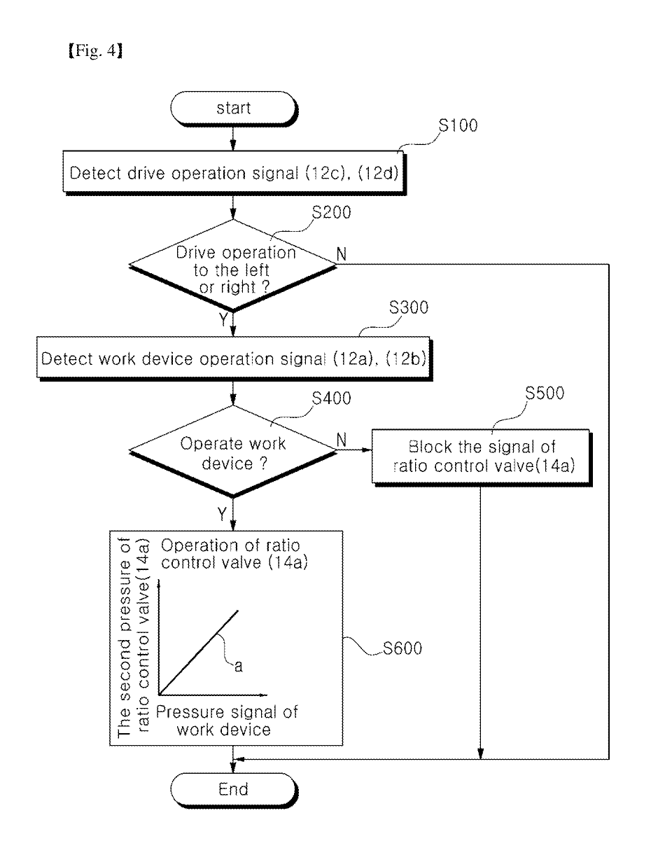

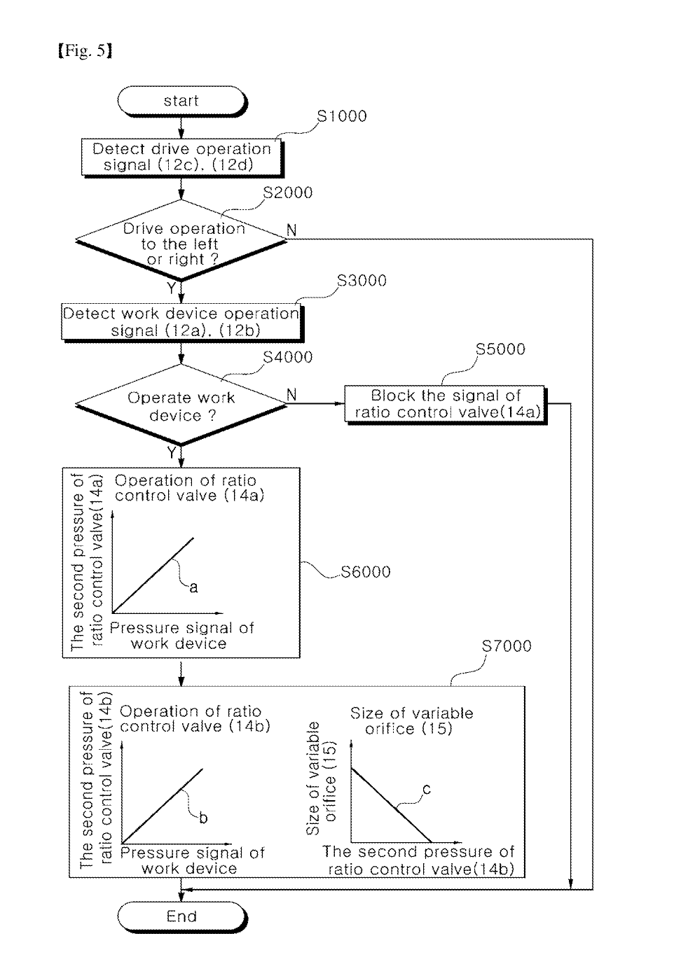

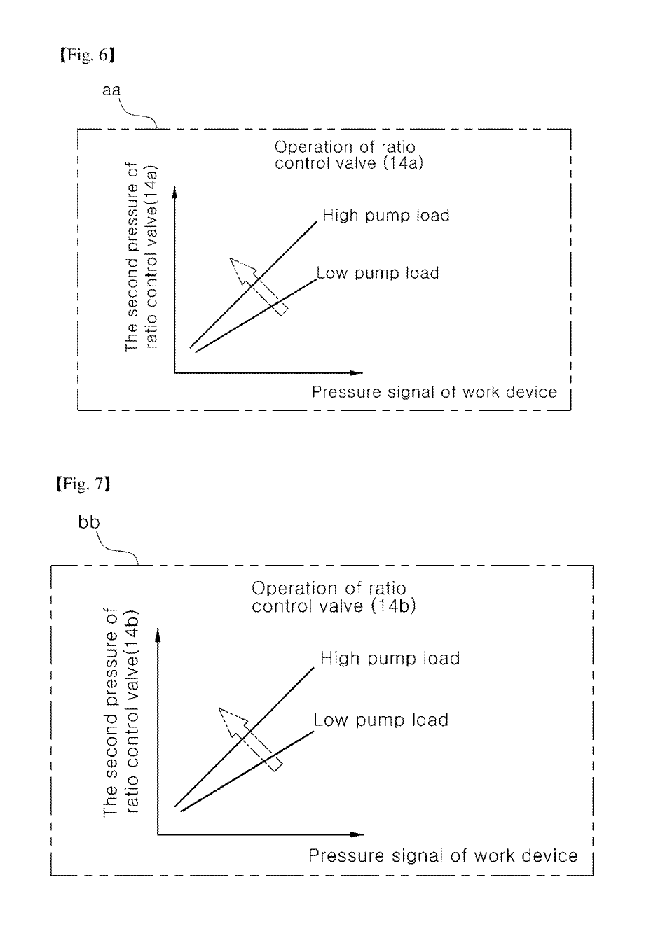

FIG. 2 represents the hydraulic circuit of the drive control device for the construction equipment according to an embodiment of the present invention. FIG. 3 represents the hydraulic circuit of the drive control device for the construction equipment according to another embodiment of the present invention. FIG. 4 shows the flow chart of the drive control method for the construction equipment according to an embodiment of the present invention. FIG. 5 is the flow chart of the drive control method for the construction equipment according to another embodiment of the present invention. FIG. 6 is the graph showing the modified control of a first ratio control valve of the drive control device for the construction equipment according to an embodiment of the present invention. FIG. 7 is the graph showing the modified control of a second ratio control valve of the drive control device for the construction equipment according to an embodiment of the present invention.

With reference to FIG. 2, the drive control device for construction equipment according to an embodiment of the present invention comprises;

a variable capacity type of a first and second hydraulic pumps (hereinafter, a first and a second hydraulic pump) (P1,P2) and a pilot pump (11),

a first work device and a first drive motor (not shown in Figure) operated by a hydraulic oil of the first hydraulic pump (P1),

a second work device and a second drive motor (not shown in Figure) operated by a hydraulic oil of the second hydraulic pump (P2),

a first drive control valve (6a) and a first work device control valve (9) that are provided on the supply path (16) of the first hydraulic pump (P1), and in switching, control the amount and flow direction of a hydraulic oil which is fed to the first drive motor and the first work device, respectively,

a second drive control valve (6b) and a second work device control valve (8) that are provided on the supply path (17) of the second hydraulic pump (P2), and in switching, control the amount and flow direction of a hydraulic oil which is fed to the second drive motor and the second work device, respectively,

a linear drive control valve (7) that is provided at the upper side of the supply path (17) of the second hydraulic pump (P2) and maintains the drive linearity by switching when the multiple activities are performed by operating a work device with the driving,

a parallel path (21) having an inlet branched and connected to the upper side of the supply path (17) of the second hydraulic pump (P2) and an outlet connected to the inlet port of the second work device control valve (8),

a branch path (24) having an inlet branched and connected to a predetermined position of the parallel path (21) and an outlet branched and connected to a path (20) between the linear drive control valve (7) and the second drive control valve (6b),

a check valve and a fixed orifice (13) provided on the branch path (24), the fixed orifice preventing the hydraulic oil from being weighted towards the drive side from the second hydraulic pump (P2) in case that the load pressure applied to a work device is higher than that applied to the drive when the linear drive control valve (7) is switched for the multiple activities of operating a work device with the driving, and

a first ratio control valve (14a) provided on a path (18) between the pilot pump (11) and the linear drive control valve (7), the first ratio control valve (14a) applying to the linear drive control valve (7) the pilot pressures that are changed in proportion to the operating oil amounts required for the operation of the first and second work device levers (4b, 4a) when the multiple activities are performed by operating the work device with the driving.

With reference to FIG. 4, the drive control device for construction equipment according to an embodiment of the present invention comprises;

a variable capacity type of a first and second hydraulic pumps (hereinafter, a first and a second hydraulic pump) (P1,P2) and a pilot pump (11),

a first work device and a first drive motor (not shown in Figure) operated by a hydraulic oil of the first hydraulic pump (P1),

a second work device and a second drive motor (not shown in Figure) operated by a hydraulic oil of the second hydraulic pump (P2),

a first drive control valve (6a) and a first work device control valve (9) that are provided on the supply path (16) of the first hydraulic pump (P1),

a second drive control valve (6b) and a second work device control valve (8) that are provided on the supply path (17) of the second hydraulic pump (P2),

a linear drive control valve (7) that is provided at the upper side of the supply path (17) of the second hydraulic pump (P2),

first, second, third and fourth pressure sensors (12d, 12c, 12b, 12a) for detecting the operating oil amounts required for the operations of the drive and work device, and

a first ratio control valve (14a) provided on a path (18) between the pilot pump (11) and the linear drive control valve (7).

With reference to FIG. 4, the drive control method for construction equipment according to an embodiment of the present invention comprises;

a step (S100, S200) determining the operation states of first and second drive motors by the operation signals of first and second pressure sensors(12d, 12c) detecting the operating oil amount of the drive operation devices (3a, 3b),

a step (S300, S400) determining the operation states of a work device by the operation signals of third and fourth pressure sensors (12b, 12a) detecting the operating oil amounts of the work operation levers (4b, 4a),

a step (S500) blocking a pilot pressure applied to the linear drive control valve (7) from the pilot pump (11) when the first and second drive motors are working and the work device is not working, and

a step (S600) applying to the linear drive control valve (7) the pilot pressures that are changed by the first ratio control valve (14a) in proportion to the operating oil amounts of the pilot pump (11) required for the operation of the first and second work device levers (4b, 4a) when the first and second drive motors as well as the work device are working.

As shown in S100 of FIG. 4 of the configuration described above, the operating oil amounts of the first and second drive operation devices (3a, 3b) are detected by the first and second pressure sensors(12d, 12c), and the operation signals thus detected are inputted to the controller (10). As shown in S200, the operation states of the first and second drive motors are determined by the operation signals inputted from the first and second pressure sensors (12d, 12c). If the first and second drive motors are operated, it proceeds with S300, and if the first and second drive motors are not operated, it ends.

As shown in S300, the operating oil amounts of the first and second work operation levers (4b, 4a) are detected by the third and fourth pressure sensors(12b, 12a), and the operation signals thus detected are inputted to the controller (10).

As shown in S400, the operation states of the work device is determined by the operation signals inputted from the third and fourth pressure sensors (12b, 12a). If the work device is not operated, it proceeds with S500, and if the work device is operated, it proceeds with S600.

As shown in S500, if the first and second drive motors are operated while the work device is not operated, the first ratio control valve (14a) stays in off-state since the electrical signal is not applied to the first ratio control valve (14a) from the controller (10). As a result, the pilot pressure applied to the linear drive control valve (7) from the pilot pump (11) is blocked.

As shown in S600, if the first and second drive motors as well as the work device are working (multiple activities of operating work device and driving), the first ratio control valve (14a) changes the pilot pressure to the second pilot pressure in proportion to the operating oil amounts of the pilot pump (11) required for the operation of the first and second work device levers (4b, 4a). (shown as the graph line “a” in FIG. 4) That is, the second pilot pressure changed by the first ratio control valve (14a) is applied to the linear drive control valve (7) which is then switched. Consequently, the shock generation can be reduced since the switching speed of the linear drive control valve (7) can be controlled by the operating oil amounts of the first and second work device levers (4b, 4a).

As shown in FIG. 2 and FIG. 6, when the multiple activities are performed by operating the work device with the driving, if the operation pressure of the second hydraulic pump (P2) detected by a fifth pressure sensor (12e) is lower than the predetermined pressure, the pilot pressure applied to the linear drive control valve (7) from the first ratio control valve (14a) is reduced, and if the operation pressure of the second hydraulic pump (P2) is higher than the predetermined pressure, the pilot pressure applied to the linear drive control valve (7) from the first ratio control valve (14a) is raised.

With reference to FIG. 3, the drive control device for construction equipment according to another embodiment of the present invention comprises;

a variable capacity type of a first and second hydraulic pumps (hereinafter, a first and a second hydraulic pump) (P1,P2) and a pilot pump (11),

a first work device and a first drive motor (not shown in Figure) operated by a hydraulic oil of the first hydraulic pump (P1),

a second work device and a second drive motor (not shown in Figure) operated by a hydraulic oil of the second hydraulic pump (P2),

a first drive control valve (6a) and a first work device control valve (9) that are provided on the supply path (16) of the first hydraulic pump (P1),

a second drive control valve (6b) and a second work device control valve (8) that are provided on the supply path (17) of the second hydraulic pump (P2),

a linear drive control valve (7) that is provided at the upper side of the supply path (17) of the second hydraulic pump (P2),

a parallel path (21) having an inlet branched and connected to the upper side of the supply path (17) of the second hydraulic pump (P2) and an outlet connected to the inlet port of the second work device control valve (8),

a branch path having an inlet branched and connected to a predetermined position of the parallel path (21) and an outlet branched and connected to a path (20) between the linear drive control valve (7) and the second drive control valve (6b),

a check valve and a fixed orifice (13) provided on the branch path (24), the fixed orifice preventing the hydraulic oil from being weighted towards the drive side from the second hydraulic pump (P2) in case that the load pressure applied to a work device is higher than that applied to the drive when the linear drive control valve (7) is switched for the multiple activities of operating a work device with the driving,

a first ratio control valve (14a) provided on a path (18) between the pilot pump (11) and the linear drive control valve (7), the first ratio control valve (14a) applying to the linear drive control valve (7) the pilot pressures that are changed in proportion to the operating oil amounts required for the operation of the first and second work device levers (4b, 4a) when the multiple activities are performed by operating the work device with the driving, and

a second ratio control valve (14b) provided on a path (23) between the pilot pump (11) and the variable orifice (15), the second ratio control valve (14b) applying to the variable orifice the pilot pressures that are changed in proportion to the operating oil amounts of the pilot pump (11) required for the operation of the first and second work device levers (4b, 4a), in which the aperture area of the variable orifice (15) is regulated to be inversely proportional to the changed pilot pressure, when the multiple activities are performed by operating the work device with the driving.

With reference to FIG. 5, the drive control device for construction equipment according to another embodiment of the present invention comprises;

a variable capacity type of a first and second hydraulic pumps (hereinafter, a first and a second hydraulic pump) (P1,P2) and a pilot pump (11),

a first work device and a first drive motor (not shown in Figure) operated by a hydraulic oil of the first hydraulic pump (P1),

a second work device and a second drive motor (not shown in Figure) operated by a hydraulic oil of the second hydraulic pump (P2),

a first drive control valve (6a) and a first work device control valve (9) that are provided on the supply path (16) of the first hydraulic pump (P1),

a second drive control valve (6b) and a second work device control valve (8) that are provided on the supply path (17) of the second hydraulic pump (P2),

a linear drive control valve (7) that is provided at the upper side of the supply path (17) of the second hydraulic pump (P2),

a parallel path (21) having an inlet branched and connected to the upper side of the supply path (17) of the second hydraulic pump (P2) and an outlet connected to the inlet port of the second work device control valve (8),

a branch path (24) having an inlet branched and connected to a predetermined position of the parallel path (21) and an outlet branched and connected to a path (20) between the linear drive control valve (7) and the second drive control valve (6b),

a variable orifice (15) provided on the branch path (24),

first, second, third and fourth pressure sensors (12d, 12c, 12b, 12a) for detecting the operating oil amounts required for the operations of the drive and work device,

a first ratio control valve (14a) provided on a path (18) between the pilot pump (11) and the linear drive control valve (7), and

a second ratio control valve (14b) provided on a path (23) between the pilot pump (11) and the variable orifice (15).

With reference to FIG. 5, the drive control method for construction equipment according to another embodiment of the present invention comprises;

a step (S1000, S2000) determining the operation states of the first and second drive motors by the operation signals of first and second pressure sensors(12d, 12c) detecting the operating oil amount of the drive operation devices (3a, 3b),

a step (S3000, S4000) determining the operation states of a work device by the operation signals of third and fourth pressure sensors (12b, 12a) detecting the operating oil amounts of the work operation levers (4b, 4a),

a step (S5000) blocking a pilot pressure applied to the linear drive control valve (7) from the pilot pump (11) when the first and second drive motors are working and the work device is not working,

a step (S6000) applying to the linear drive control valve (7) the pilot pressures that are changed by the first ratio control valve (14a) in proportion to the operating oil amounts of the pilot pump (11) required for the operation of the first and second work device levers (4b, 4a) when the first and second drive motors as well as the work device are working, and

a step (S7000) applying to the variable orifice (15) the pilot pressures that are changed in proportion to the operating oil amounts of the pilot pump (11) required for the operation of the first and second work device levers (4b, 4a), in which the aperture area of the variable orifice (15) is regulated to be inversely proportional to the changed pilot pressure, when the first and second drive motors as well as the work device are working.

As shown in S1000 of FIG. 5 of the configuration described above, the operating oil amounts of the first and second drive operation devices (3a, 3b) are detected by the first and second pressure sensors(12d, 12c), and the operation signals thus detected are inputted to the controller (10). As shown in S2000, the operation states of the first and second drive motors are determined by the operation signals inputted from the first and second pressure sensors (12d, 12c). If the first and second drive motors are operated, it proceeds with S3000, and if the first and second drive motors are not operated, it ends.

As shown in S3000, the operating oil amounts of the first and second work operation levers (4b, 4a) are detected by the third and fourth pressure sensors(12b, 12a), and the operation signals thus detected are inputted to the controller (10).

As shown in S4000, the operation states of the work device is determined by the operation signals inputted from the third and fourth pressure sensors (12b, 12a). If the work device is not operated, it proceeds with S5000, and if the work device is operated, it proceeds with S6000.

As shown in S5000, if the first and second drive motors are operated while the work device is not operated, the first ratio control valve (14a) stays in off-state since the electrical signal is not applied to the first ratio control valve (14a) from the controller (10). As a result, the pilot pressure applied to the linear drive control valve (7) from the pilot pump (11) is blocked.

As shown in S6000, if the first and second drive motors as well as the work device are working (multiple activities of operating work device and driving), the first ratio control valve (14a) changes the pilot pressure to the second pilot pressure in proportion to the operating oil amounts of the pilot pump (11) required for the operation of the first and second work device levers (4b, 4a). (shown as the graph line “a” in FIG. 5) That is, the second pilot pressure changed by the first ratio control valve (14a) is applied to the linear drive control valve (7) which is then switched. Consequently, the shock generation can be reduced since the switching speed of the linear drive control valve (7) can be controlled by the operating oil amounts of the first and second work device levers (4b, 4a).

As shown in S7000, when the first and second drive motors as well as the work device are working, by applying the electrical signal to the second ratio control valve (14b) from the controller (10), the second ratio control valve (14b) changes the pilot pressure to the second pilot pressure in proportion to the operating oil amounts of the pilot pump (11) required for the operation of the first and second work device levers (4b, 4a). (shown as the graph line “b” in FIG. 5)

On the other hand, the changed pilot pressure is applied to the variable orifice (15), in which the aperture area of the variable orifice (15) is regulated to be inversely proportional to the pilot pressure changed by the second ratio control valve (14b) (shown as the graph line “c” in FIG. 5)

Accordingly, when the multiple activities are performed by operating the work device during the driving, if the load pressure generated on the work device is relatively higher than the load pressure generated on the drive, the aperture area of the variable orifice (15) is reduced so that the operating oil fed to second work device control valve (8) through the parallel path (21) from the second hydraulic pump (P2) is not weighted towards the drive. Thus, the shock generation can be reduced while the work device can be smoothly operated.

As shown in FIG. 7, when the multiple activities are performed by operating the work device with the driving, if the operation pressure of the second hydraulic pump (P2) that is detected by a fifth pressure sensor (12e) is lower than the predetermined pressure, the pilot pressure applied to the variable orifice (15) from the second ratio control valve (14b) is reduced so that the aperture area of the variable orifice is reduced to the predetermined area; and if the detected operation pressure of second hydraulic pump (P2) is relatively higher than the predetermined pressure, the pilot pressure applied to the variable orifice (15) from the second ratio control valve (14b) is raised so that the aperture area of the variable orifice (15) is reduced further below the predetermined area.

Although the present invention has been described with reference to the preferred embodiment in the attached figures, it is to be understood that various equivalent modifications and variations of the embodiments can be made by a person having an ordinary skill in the art without departing from the spirit and scope of the present invention as recited in the claims.

### INDUSTRIAL APPLICABILITY

According to the present invention having the above-described configuration, when the work device is operated during the driving, the work device can be smoothly operated by preventing the operating oil from being weighted towards the drive which has relatively low operation pressure. The shock generation can be reduced at the start and end of the work device operation. Also, since the rapid increase or the rapid decrease of the driving speed can be prevented at the start or end of the work device operation, respectively, it is effective in improving the operability and preventing the safety accident in advance.

What is claimed is:

1. A drive control device for the construction equipment comprising;
a first and second hydraulic pumps and a pilot pump,
a first work device and a first drive motor operated by a hydraulic oil of the first hydraulic pump,
a second work device and a second drive motor operated by a hydraulic oil of the second hydraulic pump,
a first drive control valve and a first work device control valve that are provided on the supply path of the first hydraulic pump, and in switching, control the amount and flow direction of a hydraulic oil which is fed to the first drive motor and the first work equipment, respectively,
a second drive control valve and a second work device control valve that are provided on the supply path of the second hydraulic pump, and in switching, control the amount and flow direction of a hydraulic oil which is fed to the second drive motor and the second work equipment, respectively,
a linear drive control valve that is provided at the upper side of the supply path of the second hydraulic pump and maintains the drive linearity by switching when the multiple activities are done by operating a work device with the driving,
a parallel path having an inlet branched and connected to the upper side of the supply path of the second hydraulic pump and an outlet connected to the inlet port of the second work device control valve,
a branch path having an inlet branched and connected to a predetermined position of the parallel path and an outlet branched and connected to a path between the linear drive control valve and the second drive control valve,
a fixed orifice provided on the branch path, the fixed orifice preventing the hydraulic oil from being weighted towards the drive side from the second hydraulic pump in case that the load pressure applied to a work device is higher than that applied to the driving when the linear drive control valve is switched for the multiple activities of operating a work device with the driving, and
a first ratio control valve provided on a path between the pilot pump and the linear drive control valve, the first ratio control valve applying to the linear drive control valve the pilot pressures that are changed in proportion to the operating oil amounts required for the operation of the first and second work device levers when the multiple activities are performed by operating the work device with the driving.

2. The drive control device for the construction equipment comprising;
a first and second hydraulic pumps and a pilot pump,
a first work device and the first drive motor operated by the hydraulic oil of the first hydraulic pump,
a second work device and the second drive motor operated by the hydraulic oil of the second hydraulic pump,
a first drive control valve and the first work device control valve that are provided on the supply path of the first hydraulic pump, and in switching, control the amount and flow direction of a hydraulic oil which is fed to the first drive motor and the first work equipment, respectively,
a second drive control valve and the second work device control valve that are provided on the supply path of the second hydraulic pump, and in switching, control the amount and flow direction of the hydraulic oil which is fed to the second drive motor and the second work equipment, respectively,
a linear drive control valve that is provided at the upper side of the supply path of the second hydraulic pump and maintains the drive linearity by switching when the multiple activities are performed by operating a work device with the driving,
a parallel path having an inlet branched and connected to the upper side of the supply path of the second hydraulic pump and an outlet connected to the inlet port of the second work device control valve,
a branch path having an inlet branched and connected to a predetermined position of the parallel path and an outlet branched and connected to a path between the linear drive control valve and the second drive control valve,
a fixed orifice provided on the branch path, the fixed orifice preventing the hydraulic oil from being weighted towards the drive side from the second hydraulic pump in the case that the load pressure applied to a work device is higher than that applied to the driving when the linear drive control valve is switched for the multiple activities of operating a work device with the driving,
a first ratio control valve provided on a path between the pilot pump and the linear drive control valve, the first ratio control valve applying to the linear drive control valve the pilot pressures that are changed in proportion to the operating oil amounts required for the operation of the first and second work device levers when the multiple activities are performed by operating the work device with the driving, and
a second ratio control valve provided on a path between the pilot pump and the variable orifice, the second ratio control valve applying to the variable orifice the pilot pressures that are changed in proportion to the operating oil amounts required for the operation of the first and second work device levers, in which the aperture area of the variable orifice is regulated to be inversely proportional to the changed pilot pressure, when the multiple activities are performed by operating the work device with the driving.

3. The drive control device for the construction equipment of claim 1, further comprising;
a first pressure sensor detecting the operating oil amount of a first drive operation device for switching the first drive control valve,
a second pressure sensor detecting the operating oil amount of a second drive operation device for switching the second drive control valve,
a third pressure sensor detecting the operating oil amount of a first work device lever for switching the first work device control valve,
a fourth pressure sensor detecting the operating oil amount of a second work device lever for switching the second work device control valve, and
a controller that calculates the operation signals inputted from the first, second, third and fourth pressure sensors and applies the electrical signal to the first ratio control valve for the switching thereof.

4. The drive control device for the construction equipment of claim 2, further comprising;
a first pressure sensor detecting the operating oil amount of a first drive operation device for switching the first drive control valve,
a second pressure sensor detecting the operating oil amount of a second drive operation device for switching the second drive control valve,
a third pressure sensor detecting the operating oil amount of a first work device lever for switching the first work device control valve,
a fourth pressure sensor detecting the operating oil amount of a second work device lever for switching the second work device control valve, and
a controller that calculates the operation signals inputted from the first, second, third and fourth pressure sensors and applies the electrical signal to the first ratio control valve for the switching thereof.

5. The drive control device for the construction equipment of claim 2, wherein an external signal port is configured so that the aperture area of the variable orifice is regulated by the pilot pressure inputted externally.

6. The drive control device for the construction equipment of claim 2, wherein the aperture area of the variable orifice is regulated to be inversely proportional to the difference between the load pressure generated on the work device and the load pressure generated on the drive part.

7. The drive control device for the construction equipment of claim 3, further comprising;
a fifth pressure sensor inputting to the controller the pressure value detected from the first hydraulic pump, and
a sixth pressure sensor inputting to the controller the pressure value detected from the second hydraulic pump.

8. The drive control device for the construction equipment of claim 4, further comprising;
a fifth pressure sensor inputting to the controller the pressure value detected from the first hydraulic pump, and
a sixth pressure sensor inputting to the controller the pressure value detected from the second hydraulic pump.

9. A drive control method for the construction equipment comprising;
determining the operation state of the first and second drive motors,
determining the operation state of the work device, and
applying by the first ratio control valve, to the linear drive control valve the pilot pressures that are changed in proportion to the operating oil amounts required for the operation of the first and second work device levers, when the first and second drive motors as well as the work device are working.

10. The drive control method for the construction equipment of claim 9, further comprising, a step of blocking a pilot pressure applied to a linear drive control valve from a pilot pump when the first and second drive motors are operated and the work device is not operated.

11. The drive control method for the construction equipment comprising;
determining the operation state of the first and second drive motors,
determining the operation state of the work device,
applying by the first ratio control valve, to the linear drive control valve the pilot pressures that are changed in proportion to the operating oil amounts required for the operation of the first and second work device levers, when the first and second drive motors as well as the work device are operated, and
applying by the second ratio control valve, to the variable orifice the pilot pressures that are changed in proportion to the operating oil amounts required for the operation of the first and second work device levers, wherein the aperture area of the variable orifice is regulated to be inversely proportional to the changed pilot pressure, when the first and second drive motors as well as the work device are operated.

12. The drive control method for the construction equipment of claim 11, further comprising, a step of blocking a pilot pressure applied to a linear drive control valve from a pilot pump when the first and second drive motors are operated and the work device is not operated.

13. The drive control method for the construction equipment of claim 11, wherein, if the operation pressure detected of the second hydraulic pump is lower than the predetermined pressure, the pilot pressure applied to the linear drive control valve from the first ratio control valve is reduced, and if the operation pressure detected of the second hydraulic pump is higher than the predetermined pressure, the pilot pressure applied to the linear drive control valve from the first ratio control valve is raised, when the first and second drive motors as well as the work device are operated.

14. The drive control method for the construction equipment of claim 11, wherein, if the operation pressure detected of the second hydraulic pump is lower than the predetermined pressure, the pilot pressure applied to the variable orifice from the second ratio control valve is reduced so that the aperture area of the variable orifice is reduced to the predetermined area, and if the operation pressure detected of the second hydraulic pump is higher than the predetermined pressure, the pilot pressure applied to the variable orifice from the second ratio control valve is raised so that the aperture area of the variable orifice is reduced further below the predetermined area, when the first and second drive motors as well as the work device are operated.
